(19) United States
(12) Patent Application Publication
(10) Pub. No.: US 2026/0358139 A1
(43) Pub. Date: Nov. 12, 2026

(54) APPARATUS AND METHODS FOR ROAD NETWORK REGISTRATION

(71) Applicant: QUALCOMM Incorporated, San Diego, CA (US)

(72) Inventors: Yufeng HE, Chengdu (CN); Ling CHEN, Chengdu (CN); Xinyu LIN, Chengdu (CN); Xuemei ZHENG, Chengdu (CN)

(21) Appl. No.: 19/139,285

(22) PCT Filed: Feb. 28, 2023
(86) PCT No.: PCT/CN2023/078631

§ 371 Date: Jun. 13, 2025

(51) Int. Cl. G01C 21/00

(52) U.S. Cl. CPC G01C 21/3859; G01C 21/3815

(57) ABSTRACT

Methods, systems, and apparatuses to determine a first topology of a reference skeleton model and a second topology of a sensed skeleton model. The first topology and the second topology each identifying and characterizing one or more nodes. In some examples, an apparatus may perform operations that adjust a positioning of one or more data points of the second dataset based at least on the one or more nodes of the first topology and the one or more nodes of the second topology.

### FIELD OF DISCLOSURE

The disclosed embodiments generally relate to point-to-point matching be tween two data point sets.

### BACKGROUND

In various examples, a computing system may utilize a conventional point-to-point matching process to determine point-to-point correspondences between data corresponding to a road network obtained from a computing device and reference data corresponding to the same road network. Given the potential size of the road network, applying the conventional one or more point-to-point matching processes to the data obtained from the computing device and the reference data to determine the point-to-point correspondences may require an enormous amount of computational resources. To reduce the computational load required to determine the point-to-point correspondences, the conventional point-to-point matching processes may divide or segment the data obtained from the computing device and the reference data or corresponding road network into smaller portions or segments, such as tiles, and process each portion or segment to determine the point-to-point correspondences. However, the conventional point-to-point matching process may be inconsistent or inaccurate where the data obtained from the computing device and the reference data are segmented. For example, a particular data point or element of one segment (either the data obtained from the computing device or the reference data) may be included in another segment. Further, any inferences or determinations that the computing system may obtain or determine from such data points or elements may be inconsistent in such corresponding segments.

### SUMMARY

According to one aspect an apparatus may comprise a memory and at least one processor coupled to the memory. The at least one processor may be configured to generate a reference skeleton model based on a first dataset. Additionally, the at least one processor may be configured to obtain a second dataset associated with the road network, and generate a sensed skeleton model based on the second dataset. Moreover, the at least one processor may be configured to determine a first topology of the reference skeleton model and a second topology of the sensed skeleton model. In some examples, the first topology and the second topology each identify and characterize one or more nodes. Further, the at least one processor may be configured to, based at least on the one or more nodes of the first topology and the one or more nodes of the second topology, perform operations that adjust a positioning of one or more data points of the second dataset.

According to another aspect a non-transitory, machine-readable storage medium storing instruction that, when executed by at least one processor of a server, may cause the at least one processor to perform operations that include generating a reference skeleton model based on a first dataset. Additionally, the operations may include obtaining a second dataset associated with the road network, and generating a sensed skeleton model based on the second dataset. Moreover, the operations may include determining a first topology of the reference skeleton model and a second topology of the sensed skeleton model. In some examples, the first topology and the second topology each identify and characterize one or more nodes. Further, the operations may include, based at least on the one or more nodes of the first topology and the one or more nodes of the second topology, performing operations that adjust a positioning of one or more data points of the second dataset.

According to another aspect a method may include generating a reference skeleton model based on a first dataset. Additionally, the method may include obtaining a second dataset associated with the road network, and generating a sensed skeleton model based on the second dataset. Moreover, the method may include determining a first topology of the reference skeleton model and a second topology of the sensed skeleton model. In some examples, the first topology and the second topology each identify and characterize one or more nodes. Further, the method may include, based at least on the one or more nodes of the first topology and the one or more nodes of the second topology, performing operations that adjust a positioning of one or more data points of the second dataset.

### BRIEF DESCRIPTION OF THE DRAWINGS

FIG. 1 is a block diagram of an exemplary computing environment, in accordance with some exemplary embodiments;

FIGS. 2-3 are block diagrams illustrating a portion of an exemplary computing environment, in accordance with some exemplary embodiments;

FIGS. 4A and 4B illustrate example abstracted road network models, in accordance with some exemplary embodiments;

FIGS. 5A, 5B, 6 and 7 illustrate example skeleton models, in accordance with some exemplary embodiments;

FIGS. 8A and 8B illustrate an example sliding window process, in accordance with some exemplary embodiments; and

FIG. 9 is a flowchart of an exemplary process for optimizing sensed data obtained from a user device.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein are directed to a computing system that determines one or more point-to-point correspondences between sensed data corresponding to a road network and reference data corresponding to the same road network. As described herein, sensed data may include data identifying one or more three-dimensional data points that each indicate a three-dimensional position of one or more objects associated with one or more roads of a road network. Additionally, referenced data may include a set of three-dimensional data points that characterize a high definition three-dimensional map of one or more road networks. In such embodiments, the computing system may determine a road topology associated with the sensed data and a road topology associated with the reference data. Additionally, the computing system may determine the point-to-point correspondences between the sensed data and the reference data based on the determined road topologies. Moreover, the computing system may determine, for each of the point-to-point correspondences, any deviations or differences that may exist and optimize the sensed data based on the determined deviations or differences. As described herein, the sensed data may be optimized to have as minimal of a difference or deviation to the reference data, for example, without compromising the overall shape and form of data points, such as three-dimensional data points, that may be included in the sensed data.

### A. Exemplary Computing Environments

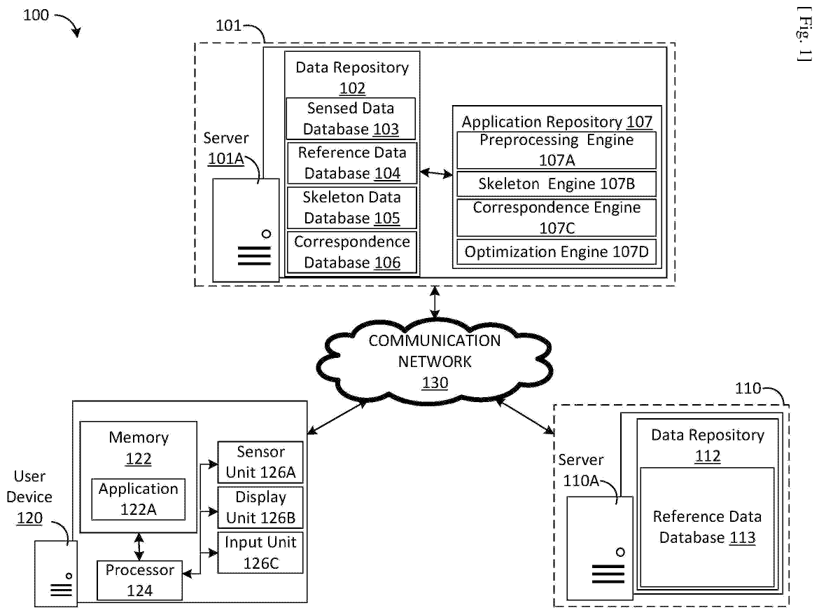

FIG. 1 illustrates a block diagram of an example computing environment that includes, among other things, one or more computing systems, such as road network computing system 101 and one or more source computing systems 110, and one or more user devices, such as user device 120. Each of the one or more computing systems, such as road network computing system 101 and one or more source computing systems, such as source computing system 110, and the one or more user devices, such as user device 120 may each be operatively connected to, and interconnected across, one or more communications networks, such as communications network 130. Examples of communications network 130 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

As illustrated in FIG. 1, road network computing system 101 may be associated with a navigation or mapping provider, and may be operated by one or more operators of the mapping or navigation provider. Additionally, road network computing system 101 may perform any of the exemplary processes described herein to determine one or more point-to-point correspondences between sensed data obtained from user device 120, and reference data maintained and stored in one or more source computing systems, such as source computing system 110. As described herein, the sensed data obtained from user device 120 and the reference data may each correspond to a road network. Moreover, road network computing system 101 may determine a topology of the road network associated with the sensed data and a topology of the road network associated with the reference data, based on the sensed data and the reference data, respectively. Further, road network computing system 101 may take into account the topology of the road network of the data of user device 120 and the topology of the road network of the reference data when determining the one or more point-to-point correspondences between the sensed data and the reference data. In some instances, road network computing system 101 may determine, for each of the point-to-point correspondences, any deviations or differences that may exist and optimize the sensed data based on the determined deviations or differences. In such instances, road network computing system 101 may optimize the sensed data to have as minimal of a difference or deviation to the reference data without compromising the overall shape and form of the three-dimensional data points included in the sensed data.

To facilitate the performance of the exemplary processes, road network computing system 101 may maintain within the one or more tangible, non-transitory memories data repository 102 that includes, but is not limited to, sensed data database 103, reference data database 104, skeleton data database 105 and correspondence data database 106. As described herein, sensed data database 103 may store sensed data including one or more three-dimensional data points. Each of the one or more three-dimensional data points may characterize a three-dimensional position or reference point of one or more objects within a field of view of a sensor, such as a light detection and ranging (LIDAR) sensor, operatively or communicatively coupled to user device 120. The one or more objects may be associated with one or more roads of a road networks, such as signs, trees, rail guards, buildings, traffic lights, street lights, on or near one or more roads of a road network user device 120, such as a vehicle, may be traveling on.

In some examples, the sensed data may include image data including one or more images that are each associated with a portion of the data identifying the one or more three-dimensional data points. In such examples, each of the one or more images may be of an environment captured by a sensor, such as a monocular camera. The one or more images of the environment may include images of one or more roads or road networks user device 120, such as a vehicle, may be traveling on. In various instances, road network computing system 101 may obtain the sensed data from user device 120. In such instances, road network computing system 101 may store the obtained sensed data within portions of sensed data database 103. In other instances, road network computing system 101 may obtain sensor data and/or image data from user device 120 and generate the sensed data based on the sensor data and/or the image data. In such instances, road network computing system 101 may store the generated sensed data within portions of sensed data database 103.

Additionally, reference data database 104 may store reference data obtained from one or more source systems, such as source system 110.

As described herein, the reference data may include a set of three-dimensional data points that characterize a high definition three-dimensional map of one or more road networks. Additionally, the data, such as the set of three-dimensional data points, of a high definition three-dimensional map may be of a higher level of granularity (e.g., centimeter-level accuracy) than a standard definition three-dimensional map (e.g., meter-level accuracy). Further, due to the granularity of the data of the high definition three-dimensional map, the data of the high definition three-dimensional map may include information about a road network that is of higher detail as compared to the data of the standard definition three-dimensional map. For example, the data of the standard definition three-dimensional map may characterize the topology of a road network, while the data of the high definition three-dimensional map may characterize the topology of the road network as well as lane level information, such as lane lines, road surface arrows, and other semantic markings of the road network.

The high definition three-dimensional map may be based on sensor data and/or image data generated from one or more sensors of one or more devices, such as one or more vehicles, associated with the source system (e.g., source system 110). Examples of the one or more sensors may include a light detection and ranging (LIDAR) sensor, a radar sensor and/or a camera. In some instances, the three-dimensional data points that make up the high definition three-dimensional map may be more precise, relative to the corresponding points in the actual road network of the real world, than the three-dimensional data points of the sensed data. In other instances, the reference data may include data characterizing one or more road features of one or more roads of each of the road networks characterized by the reference data. Examples of the one or more road features include, lane markings, the shape of the road and the texture of the road. In various instances, the reference data may include data identifying and characterizing one or more traffic elements or objects associated with or near each of the roads of each of the road networks characterized by the reference data. Examples of the one or more traffic elements or objects includes signs (e.g, traffic, commercial, residential, etc.), trees, rail guards, buildings, traffic lights, and street lights.

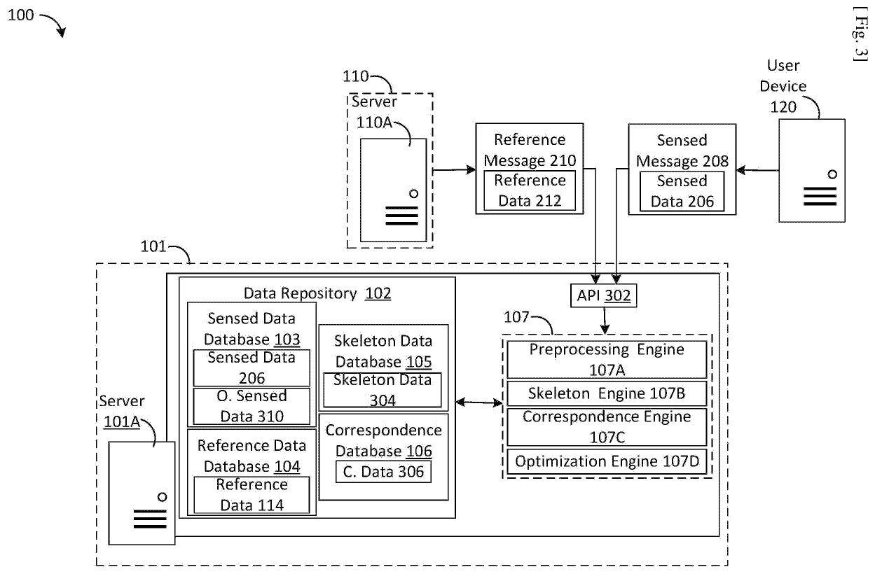

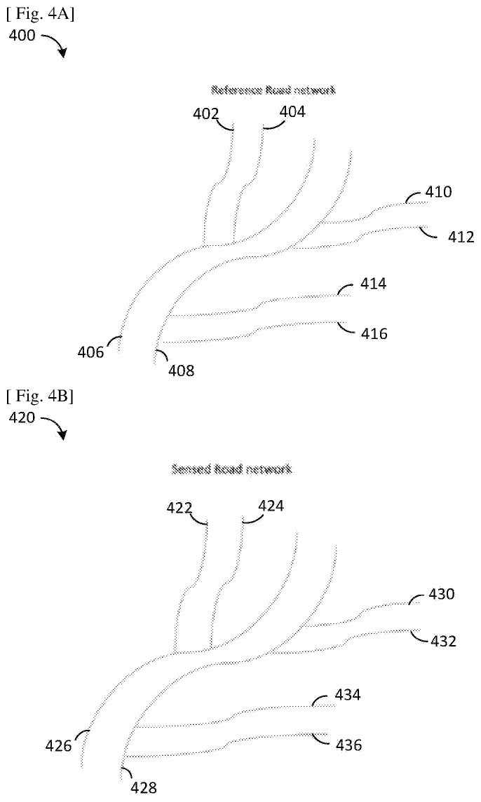

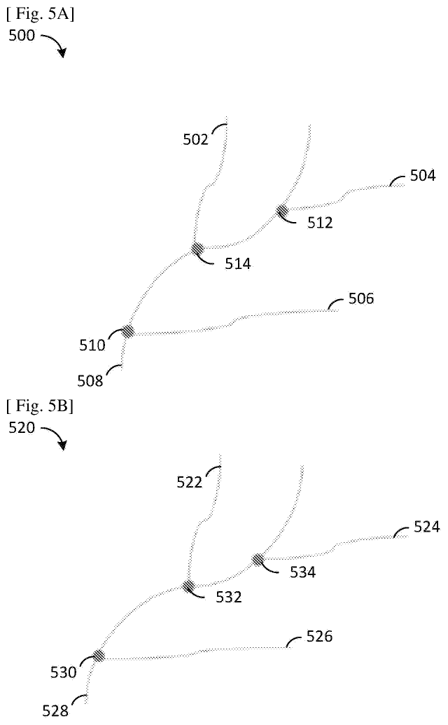

Moreover, skeleton data database 105 may maintain and store skeleton data generated by road network computing system 101. As described herein, the skeleton data may characterize a skeleton model of each of one or more road networks characterized by the sensed data and/or reference data. Additionally, the skeleton models may be based on an abstract or simplified road network model derived from the reference data or the sensed data. For example, referring to FIG. 4A, a road network model of a road network generated from reference data, such as reference road network model 400, may include one or more roads or branches. Additionally, each road may be defined by corresponding road boundaries. For instance, a first road may be defined by boundary 402 and 404, a second road may be defined by boundary 406 and boundary 408, a third road may be defined by boundary 410 and boundary 412, and a fourth road may be defined by boundary 414 and boundary 416. Additionally, referring to FIG. 5A, a skeleton model, such as reference skeleton model 500, may be an abstract representation of a road network model, such as reference road network model 400. In some instances, the skeleton model, such as reference skeleton model 500, may include lines or edges representing the roads of the road network model, such as reference road network model 400.

Additionally, the skeleton model may include nodes representing intersections or junctions of the road network model. For instance, reference skeleton model 500 may include lines 502, 504, 506 and 508 and nodes 510, 512 and 514. Line 502 may represent the first road, line 504 may represent the third road, line 506 may represent the second road, and line 508 may represent the fourth road. Additionally, nodes 510, 512 and 514 may each represent an intersection or junction of the road network characterized by the reference data.

Further, correspondence data database 106 may maintain and store rough correspondence data and/or fine correspondence data. As described herein, the rough correspondence data may include information that characterizes a lower level of data point granularity as compared to the fine correspondence data. For example, the rough correspondence data may identify and characterize portions of the sensed data that correspond to portions of the reference data (e.g., a grouping of data points of the sensed data that correspond to a grouping of data points of the reference data that identify a junction), while the fine correspondence data may identify, for each data point of the sensed data, a corresponding data point of the reference data.

In some examples, rough correspondence data may be based on a comparison between portions of skeleton models of the sensed data and portions of skeleton models of the reference data. Additionally, rough correspondence data may identify and characterize one or more line or edge correspondences. As described herein, a line or edge correspondence may indicate, for a particular line or edge of a skeleton model of the reference data, a corresponding line or edge of a skeleton model of the sensed data. In other examples, fine correspondence data may be based on a comparison between data points or elements, such as three-dimensional data points, included in the reference data and data point or elements, such as three-dimensional data points, included in the sensed data. Additionally, the fine correspondence data may characterize and identify point-to-point correspondences between the reference data and the sensed data. As described herein, each point-to-point correspondence may identify and characterize a three-dimensional data point of a high definition three-dimensional map of a road network characterized by the reference data and a corresponding three-dimensional data point of a three-dimensional map of a road network characterized by the sensed data.

Further, and to facilitate the performance of any of the exemplary processes described herein, road network computing system 101 may include server 101A that may maintain within the one or more tangible non-transitory memories, an application repository 107. Application repository 107 may include, among other things, preprocessing engine 107A, skeleton engine 107B, correspondence engine 107C and optimization engine 107D. Additionally, the one or more processors of server 101A may execute, among other things, preprocessing engine 107A, skeleton engine 107B, correspondence engine 107C and optimization engine 107D to determine the one or more point-to-point correspondences between data obtained from user device 120, such as the sensed data, and reference data maintained and stored in one or more source computing systems, such as source computing system 110. Additionally, the one or more processors of server 101A may execute, among other things, preprocessing engine 107A, skeleton engine 107B, correspondence engine 107C and optimization engine 107D to take into account the topology associated with the road network of the data obtained from user device 120 and/or the topology associated with the road network of the reference data when making such point-to-point correspondence determinations. Further, the one or more processors of server 101A may execute, among other things, preprocessing engine 107A, skeleton engine 107B, correspondence engine 107C and optimization engine 107D to optimize the sensed data based on deviations determined from the point-to-point correspondences Preprocessing engine 107A may be executed by the one or more processors of server 101A to obtain or receive sensed data from user device 120 and/or reference data from one or more source computing systems, such as source computing system 110. In some instances, executed preprocessing engine 107A may store sense data within a corresponding portion of data repository 102, such as sensed data database 103. As described herein, the sensed data may include data identifying one or more three-dimensional data points that each indicate a three-dimensional position of one or more objects associated with one or more roads of a road network. Additionally, the sensed data may also include image data including one or more images and data indicating which of the one or more images corresponding to which of the three-dimensional data points. The one or more images may be of one or more portions of one or more roads of the road network. In other instances, executed preprocessing engine 107A may store reference data within a corresponding portion of data repository 102, such as reference data database 104. As described herein, the reference data may include a set of three-dimensional data points that characterize a high definition three-dimensional map of one or more road networks. Additionally, the reference data may also include data characterizing one or more road features of one or more roads of each of the road networks and/or data characterizing one or more objects associated with or near each of the roads of each of the road networks characterized by the reference data. Moreover, the reference data may be of higher precision than the sensed data.

In some examples, executed preprocessing engine 107A may generate the sensed data. As described herein the sensed data may include data identifying one or more three-dimensional data points that each indicate a three-dimensional position of one or more objects associated with one or more roads of a road network. In such examples, executed preprocessing engine 107A may obtain or receive sensor data from user device 120. User device 120 may include a first sensor, such as a light detection and ranging (LIDAR) sensor, configured to generate sensor data associated with one or more objects within a field of view of the first sensor. The one or more objects may be associated with one or more roads of a road networks, such as signs, trees, rail guards, buildings, traffic lights, street lights, on or near one or more roads of a road network user device 120, such as a vehicle, may be on. Additionally, the one or more sensors may generate sensor data and user device 120 may transmit or provide the sensor data to road network computing system 101. Moreover, executed preprocessing engine 107A may generate sensed data based at least in part on the received or obtained sensor data. For instance, executed preprocessing engine 107A may implement operations that determine one or more three-dimensional reference points or positions of each of the one or more objects associated with the one or more roads of the road network based on the sensor data. Based on the determined three-dimensional reference points or positions of each of the one or more objects, executed preprocessing engine 107A may generate the sensed data including data identifying one or more three-dimensional data points. As described herein, the one or more three-dimensional data points may each indicate a three-dimensional position of one or more objects associated with one or more roads of a road network. In some instances, executed preprocessing engine 107A may store, within corresponding portions of data repository 102, such as sensed data database 103, the generated sensed data.

In some instances, executed preprocessing engine 107A may generate sensed data that includes portions of image data including one or more images. As described herein, each of the one or more images may be associated with a portion of the data identifying the one or more three-dimensional data points. In such instances, executed preprocessing engine 107A may obtain the image data from user device 120. User device 120 may include a second sensor, such as a monocular camera, configured to capture one or more images of an environment the user device 120 is in, such as a road of a road network. Additionally, user device 120 may generate the image data including the one or more images and a time stamp data indicating a time and/or date of when each of the one or more images were captured. Moreover, user device 120 may transmit or provide the image data to road network computing system 101. Further, executed preprocessing engine 107A may generate the sensed data based on the sensor data and the image data obtained or received from user device 120. For instance, following the example above, the sensor data may further include timestamp data indicating when each portion of the sensor data was captured/detected by the first sensor. Additionally, executed preprocessing engine 107A may associate portions of the timestamp data to the corresponding three-dimensional data points. Further, executed preprocessing engine 107A may determine which images are associated with which three-dimensional data points, based on the timestamp data of the sensor data and the timestamp data of the image data (e.g., similar or closest in time or date of capture). Based on such determinations, executed preprocessing engine 107A may generate the sensed data to include portions of the obtained image data and data indicating which of the one or more images correspond to or are associated with which three-dimensional data points. In some instances, executed preprocessing engine 107A may store, within corresponding portions of data repository 102, such as sensed data database 103, the generated sensed data.

Moreover, skeleton engine 107B may be executed by one or more processors of server 101A to obtain the sensed data from sensed data database 103 or reference data from reference data database 104 and generate, based on the sensed data and/or reference data, a corresponding skeleton model. For example, based on the reference data, executed skeleton engine 107B may generate a reference skeleton model and/or generate skeleton data characterizing the reference skeleton model. In such example, executed skeleton engine 107B may obtain the reference data and extract the three-dimensional data points of a high definition three-dimensional map of a road network along with data characterizing one or more road features of one or more roads of the road network.

Additionally, executed skeleton engine 107B may apply one or more simplification or abstraction processes to the three-dimensional data points of a high definition three-dimensional map and the corresponding one or more road features. Based on the application of the one or more simplification or abstraction processes to the three-dimensional data points and the corresponding one or more road features, executed skeleton engine 107B may remove minor details from the road features and/or reduce the number of data points of the obtained three-dimensional data points and the corresponding one or more road features to generate an abstracted or simplified version of the high definition three-dimensional map.

Further, executed skeleton engine 107B may apply one or more skeletonization processes, such as thinning algorithms or a medial axis transform, to the three-dimensional data points of the abstracted high definition three-dimensional map and the corresponding one or more road features. Based on the application of the one or more skeletonization processes to the three-dimensional data points of the abstracted high definition three-dimensional map and the corresponding one or more road features, executed skeleton engine 107B may generate the reference skeleton model. The reference skeleton model may capture the main geometric features of the one or more roads of the road network characterized by the high definition three-dimensional map of the reference data.

In some instances, executed skeleton engine 107B may implement validation and refinement processes to the generated reference skeleton model. For instance, the validation and refinement process may include comparing the generated reference skeleton model against the high definition three-dimensional map of the reference data. Additionally, the validation and refinement process may include implementing processes to refine the reference skeleton model to ensure its accuracy and completeness in accordance to the three-dimensional data points of the high definition three-dimensional map and corresponding one or more road features included in the reference data. In other instances, executed skeleton engine 107B may generate skeleton data characterizing the reference skeleton model. In such instances, executed skeleton engine 107B may store the skeleton data within corresponding portions of data repository 102, such as skeleton data database 105.

In another example, and based on the sensed data, executed skeleton engine 107B may generate a sensed skeleton model and/or generate skeleton data characterizing the sensed skeleton model. In such example, executed skeleton engine 107B may generate a three-dimensional map of a road network characterized by the sensed data and one or more road features (e.g., lane markings, the shape of the road and the texture of the road, etc.) associated with one or more roads of the road network characterized by the three-dimensional map.

Additional executed skeleton engine 107B may apply one or more simplification or abstraction processes to the three-dimensional data points of the three-dimensional map and the corresponding one or more road features. Based on the application, executed skeleton engine 107B may remove minor details from the road features and/or reduce the number of data points of the three-dimensional map and the corresponding one or more road features to generate an abstracted or simplified version of the three-dimensional map.

Further, executed skeleton engine 107B may apply one or more skeletonization processes, such as thinning algorithms or a medial axis transform, to the three-dimensional data points of the abstracted three-dimensional map and corresponding one or more road features. Based on the application of the one or more skeletonization processes to the three-dimensional data points of the abstracted three-dimensional map and corresponding one or more road features, executed skeleton engine 107B may generate the sensed skeleton model. The sensed skeleton model may capture the main geometric features of the one or more roads of the road network associated with the reference data.

In some instances, executed skeleton engine 107B may implement validation and refinement processes to the generated sensed skeleton model. For instance, the validation and refinement process may include comparing the generated sensed skeleton model against the three-dimensional map of the sensed data. Additionally, the validation and refinement process may include implementing processes to refine the sensed skeleton model to ensure its accuracy and completeness in accordance with the three-dimensional data points of the three-dimensional map of the sensed data and corresponding one or more road features. In other instances, executed skeleton engine 107B may generate skeleton data characterizing the sensed skeleton model. In such instances, executed skeleton engine 107B may store the skeleton data within corresponding portions of data repository 102, such as skeleton data database 105.

In addition, correspondence engine 107C may be executed by one or more processors of server 101A to obtain skeleton data from skeleton data database 105 and generate, based on the skeleton data, rough correspondence data and fine correspondence data. As described herein, rough correspondence data may include data identifying and characterizing line/edge correspondences between the skeleton models of the sensed data and reference data. Additionally, fine correspondence data may identify and characterize the point-to-point correspondences between the data points or elements of the reference data and the data points or elements of the sensed data.

In some examples, executed correspondence engine 107C may perform operations that determine a topology, including nodes and/or lines, of each of a sensed skeleton model and a reference skeleton model. Additionally, executed correspondence engine 107C may perform operations that utilize the nodes of the determined topologies to determine which lines or edges of the sensed skeleton model corresponds to which lines or edges of the reference skeleton model. For example, for the sensed skeleton model, executed correspondence engine 107C may identify one or more nodes included in the sensed skeleton model. Additionally, for the reference skeleton model, executed correspondence engine 107C may identify one or more nodes included in the reference skeleton model. Moreover, based on the one or more identified nodes of the skeleton model and the one or more identified nodes of the reference model, executed correspondence engine 107C may determine which of the identified nodes of the skeleton model correspond to the identified nodes of the reference model. Based on the determined node correspondences, executed correspondence engine 107C may determine, for each line or edge of the sensed skeleton model, a corresponding line or edge of the reference skeleton model. Further, based on the determined line or edge correspondence(s), executed correspondence engine 107C may generate rough correspondence data characterizing, for each line or edge of the sensed skeleton mode 1, a corresponding line or edge of the reference skeleton model. In some instances, executed correspondence engine 107C may store the generated rough correspondence data within corresponding portions of data repository 102, such as correspondence data database 106.

In some examples, executed correspondence engine 107C may perform operations that utilize the rough correspondence data to generate the fine correspondence data. As described herein, the fine correspondence data may identify and characterize, for each line or edge correspondence, one or more point-to-point correspondences. Each point-to-point correspondence may identify and characterize a three-dimensional data point of a high definition three-dimensional map of a road network characterized by the reference data and a corresponding three-dimensional data point of a three-dimensional map of a road network characterized by the sensed data. In such examples, executed correspondence engine 107C may determine, for each line or edge correspondence, one or more point-to-point correspondences based on corresponding portions of the reference data and corresponding portions of sensed data. Additionally, each of the corresponding portions of the reference data may characterize a corresponding portion of the high definition three-dimensional map and associated three-dimensional data points. Moreover, each of the corresponding portions of the sensed data may characterize a corresponding portion of the three-dimensional map and associated three-dimensional data points. In some instances, executed correspondence engine 107C may generate the fine correspondence data characterizing the determined point-to-point correspondences for each of the line/edge correspondences. In other instances, executed correspondence engine 107C may store the fine correspondence data for each of the line/edge correspondences, within corresponding portions of data repository 102, such as correspondence data database 106.

Further, executed correspondence engine 107C may apply one or more additional processes, such as a sliding window process, to each determined point-to-point correspondence. Based on the application of the one or more additional processes to each determined point-to-point correspondence, executed correspondence engine 107C may determine a difference or deviation of each point-to-point correspondence (e.g., a difference between the three-dimensional data point of the portion of reference data and corresponding three-dimensional data point of the portion of the sensed data). Each determined deviation or difference may be represented by a value or deviation value. In some instances, executed correspondence engine 107C may, for each line/edge correspondence, generate fine correspondence data characterizing the determine point-to-point correspondences along with the associated deviation value.

In examples where executed correspondence engine 107C applies a sliding window process to each determined point-to-point correspondence, each window applied to a portion of a particular edge/line correspondence may result in multiple deviation values for each point-to-point correspondence. In such examples, executed correspondence engine 107C may implement a voting process to determine which of the multiple difference/deviation values to utilize and include in the fine correspondence data of a particular line/edge correspondence. In so me instances, executed correspondence engine 107C may utilize, for a particular point-to-point correspondence, a deviation value that has the highest score representing the smallest deviation.

Referring back to FIG. 1, optimization engine 107D may be executed by one or more processors of server 101A to optimize the sensed data based on the fine correspondence data. Additionally, executed optimization engine 107D may optimize the sensed data to minimize the deviation between the three-dimensional data points the sensed data and the three-dimensional data points of the reference data. As described herein, the three-dimensional data points of the sensed data may characterize a three-dimensional map of a road network. As described herein, the three-dimensional data points of the sensed data may characterize a three-dimensional map of a road network. Moreover, executed optimization engine 107D may optimize the three-dimensional data points of the sensed data to minimize the deviation between the three-dimensional data points of the sensed data and three-dimensional data points of the reference data by rotating and/or translating the three-dimensional data points. In some examples, executed optimization engine 107D may utilize a rotation and translation matrix to optimize the sensed data. In other examples, executed optimization engine 107D may iteratively rotate and/or translate the sensed data. Additionally, executed optimization engine 107D may determine, for each iteration, a deviation value for each point-to-point correspondence and determine an average deviation value or aggregate deviation value. Based on the average or aggregate deviation value of each iteration, executed optimization engine 107D may determine an iteration that has the smallest overall deviation between the sensed data and the reference data. In some instances, executed optimization engine may generate optimized sensed data and store the optimized sensed data in corresponding portions of data repository 102, such as sensed data database 103. In other instances, executed optimization engine may transmit the optimized sensed data to user device 120. User device 120 may utilize the optimized sensed data for navigation or mapping purposes instead of the sensed data.

In other examples, executed optimization engine 107D may minimize the deviation between the three-dimensional data points of the sensed data and three-dimensional data points of the reference data without altering the overall shape and formation of the three-dimensional data points of the sensed data. For example, executed optimization engine 107D may determine the overall shape and formation of the three-dimensional data points of the sensed data by determining the relative distances and angels between each three-dimensional data point of the sensed data. Additionally, as described herein, executed optimization engine 107D may adjust the positioning (e.g., rotating and/or translating) the three-dimensional data points of the sensed data based on the corresponding determined deviation value for each point-to-point correspondence (or in some instances the average deviation value or aggregate deviation value) and the determined relative distances and angels. For instance, executed optimization engine 107D may rotate and/or translate one or more of the three-dimensional data points of the sensed data based on the determined deviation values, while maintaining the corresponding determined distances and angels.

Additionally, road network computing system 101 may communicate with one or more source computing systems, such as source computing system 110, to obtain reference data. The one or more source computing systems, such as source computing system 110, may be operated by one or more third party mapping or navigation entities. Additionally, the one or more source computing systems may represent a computing system that includes one or more servers, such as server 110A, and one or more tangible, non-transitory memory devices storing executable code, application engines, or application modules. Each of the one or more servers may include one or more processors, which may be configured to execute portions of the stored code, application engines or modules, or application programs to perform operations consistent with the disclosed exemplary embodiments. For example, as illustrated in FIG. 1, the one or more servers of source computing system 110 may include server 110A having one or more processors configured to execute portions of the stored code, application engines or modules, or application programs maintained within the one or more tangible, non-transitory memories.

Additionally, the one or more source computing systems, such as source computing system 110, may maintain within the one or more tangible, non-transitory memories, such as data repository 112, that includes, but is not limited to reference data database 113. Reference data database 113 may maintain and store reference data. As described herein, the reference data may include a set of three-dimensional data points that characterize a high definition three-dimensional map of one or more road networks. The high definition three-dimensional map may be based on sensor data and/or image data generated from one or more sensors of one or more devices, such as one or more vehicles, associated with the source system (e.g., source system 110). Examples of the one or more sensors may include a light detection and ranging (LIDAR) sensor, a radar sensor and/or a camera. In some instances, the three-dimensional data points that make up the high definition three-dimensional map may be more precise than the three-dimensional data points of the sensed data. In other instances, the reference data may include data characterizing one or more road features of one or more roads of each of the road networks characterized by the reference data. Examples of the one or more road features include, lane markings, the shape of the road and the texture of the road. In various instances, the reference data may include data identifying and characterizing one or more objects associated with or near each of the roads of each of the road networks characterized by the reference data. Examples of the one or more objects includes signs (e.g, traffic, commercial, residential, etc.), trees, rail guards, buildings, traffic lights, and street lights.

As illustrated in FIG. 1, road network computing system 101 may communicate with user device 120 to obtain sensed data or sensor data and/or image data.

User device 120 may have one or more tangible, non-transitory memories, such as memory 122, that store data and/or software instructions, and one or more processors (e.g., processor 124), configured to execute the software instructions.

The one or more tangible, non-transitory memories may, in some aspects, store application programs, application engines or modules, and other elements of code executable by the one or more processors, such as, but not limited to, an executable web browser (e.g., Google Chrome™M, Apple Safari™, etc.) , and additionally or alternatively, an executable application, such as application 122A, associated with an entity associated with road network computing system 101. In some instances, not illustrated in FIG. 1, memory 122 may also include one or more structured or unstructured data repositories or databases, and user device 120 may each maintain one or more elements of device data within the one or more structured or unstructured data repositories or databases. For example, the elements of device data may uniquely identify user device 120 within computing environment 100, and may include, but are not limited to, an Internet Protocol (IP) address assigned to user device 120 or a media access control (MAC) layer assigned to user device 120.

User device 120 may include sensor unit 126A. Sensor unit 126A may include multiple sensors. In some examples, the multiple sensors may include a first sensor, such as a light detection and ranging (LIDAR) sensor. The first sensor may be configured to generate sensor data associated with one or more objects within a field of view of the first sensor. The one or more objects may be associated with one or more roads of a road networks, such as signs, trees, rail guards, buildings, traffic lights, street lights, on or near one or more roads of a road network user device 120, such as a vehicle, may be on. In some instances, the sensor data may include time stamp data indicating when each portion of the sensor data was captured/ detected by the first sensor. In other examples, the multiple sensors may include a second sensor, such as a monocular camera, configured to generate image data that includes one or more images of an environment within a field of view of the second sensor. In some instances, the one or more images of an environment the user device 120 is in, such as a road of a road network. In other instances, the image data may include timestamp data indicating a time and/or date of when each of the one or more images were captured.

In examples where road network computing system 101 generates the sensed data, application 112A may obtain the sensor data and/or image data and transmit the sensor data and/or image data to road network computing system 101. In example where user device 120 generates the sensed data, the one or more processors of user device 120, such as processor 124, may execute application 122A to generate the sensed data based on the sensor data and/or image data. In some examples, the sensed data may be based on the sensor data. For example, executed application 122A may implement operations that determine one or more three-dimensional reference points or positions of each of the one or more objects associated with the one or more roads of the road network based on the sensor data. Based on the determined three-dimensional reference points or positions of each of the one or more objects, executed application 122A may generate the sensed data including data identifying one or more three-dimensional data points. As described herein, the one or more three-dimensional data points may each indicate a three-dimensional position of one or more objects associated with one or more roads of a road network. In some instances, executed application 122A may store, within memory 122, the generated sensed data. In other instances, executed application 122A may transmit the sensed data to road network computing system 120.

In other examples, executed application 122A may generate sensed data that includes portions of image data including one or more images. As described herein, each of the one or more images may be associated with a portion of the data identifying the one or more three-dimensional data points. For example, following the example above, executed application 122A may obtain the image data along with the sensor data. Additionally, executed application 122A may determine, for each of the one or more images of the image data and based on the timestamp data of the image data and timestamp data of the sensor data, corresponding portions of sensor data that have similar or matching timestamps. Moreover, based on such determinations, executed application 122A may generate the sensed data to also include portions of the obtained image data and data indicating which of the one or more images correspond to or are associated with which three-dimensional data points. In some instances, executed application 122A may store, within memory 122, the generated sensed data that include one or more portions of the image data and data indicating which of the one or more images correspond to or are associated with which three-dimensional data points of the sensor data. In other instances, executed application 122A may transmit the sensed data to road network computing system 120.

In various instances, user device 120 may be a vehicle. In some instances, user device 120 may be an autonomous vehicle (e.g., a vehicle with autonomous driving capabilities). In other instances, user device 120 may be a head mounted display for extended reality (XR), such as augmented reality (AR), virtual reality (VR), mixed reality (MR), etc. ) Although, FIG. 1 illustrates computing environment 100 as including one user device 120, the computing environment 100 may include any number of user devices 120.

Additionally, user device 120 may include a display unit, such as display unit 126B, configured to present interface elements to a corresponding user, such as a user of user device 120, and an input unit, such as input unit 126C, configured to receive input from the user (e.g., in response to the interface elements presented through the display unit). By way of example, the display unit may include, but is not limited to, an LCD display unit or any other appropriate type of display unit, and input unit may include, but is not limited to, a keypad, keyboard, touchscreen, voice activated control technologies, or appropriate type of input unit. Further, in additional aspects (not illustrated in FIG. 1), the functionalities of the display unit and input unit may be combined into a single device, e.g., a pressure-sensitive touchscreen display unit that presents interface elements and receives input from a user, such as user of user device 120. In various instances, user device 120 may include an embedded computing device (e.g., in communication with a smart textile or electronic fabric), and any other type of computing device that may be configured to store data and software instructions, execute software instructions to perform operations, and/or display information on an interface device or unit, such as display unit 126B.

Moreover, user device 120 may include a communications interface, such as communications interface 126D, such as a wireless transceiver device, coupled to a processor of user device 120, such as processor 124, and configured by the processor to establish and maintain communications with communications network 130 via one or more communication protocols, such as WiFi®, Bluetooth®, NFC, a cellular communications protocol (e.g., LTE®, CDMA®, GSM®, etc.) , or any other suitable communications protocol. In some instances, user device 120 may also establish communications with one or more additional computing systems or devices operating within computing environment 100 across a wired or wireless communications channel, such as communications network 130 (e.g., via the communications interface 126D using any appropriate communications protocol).

In some examples, not illustrated in FIG. 1, user device 120, similar to road network computing system 101, may perform exemplary processes to determine the one or more point-to-point correspondences between sensed data and reference data. Additionally, similar to road network computing system 101, user device 120, may take into account the topology associated with a road network of the sensed data and the topology of the reference data when making such point-to-point correspondence determinations. Further, similar to road network computing system 101, user device 120 may optimize the sensed data based on deviations determined from the point-to-point correspondences. To facilitate the performance of these exemplary processes, one or more processors of user device 120, such as processor 124, may execute one or more modules, such as preprocessing module, skeleton module, correspondence module and optimization module. As described herein, executed preprocessing module may perform operations similarly described herein with preprocessing engine 107A, executed skeleton module may perform operations similarly described herein with skeleton engine 107B, executed correspondence module may perform operations similarly described herein with correspondence engine 107C, and executed optimization module may perform operations similarly described herein with optimization engine 107D.

### B. Computer-Implemented Techniques for Optimizing Three-Dimensional Data Points of Sensed Data

As described herein, road network computing system 101 may take into account a topology of a road network of sensed data and reference data when determining one or more point-to-point correspondences between the sensed data and the reference data. As described herein, the sensed data may include one or more three-dimensional data points that may characterize a three-dimensional map of a road network, and the reference data may include one or more three-dimensional data points that may characterize a high definition three-dimensional map of the road network. In some instances, the reference data may be more precise than the sensed data. Additionally, road network computing system 101 may, for each of the point-to-point correspondences, determine any deviations or differences that may exist and optimize the sensed data based on the determined deviations or differences. As described herein, the sensed data may be optimized to have as minimal of a difference or deviation to the reference data without compromising the shape and form of the three-dimensional data points included in the sensed data.

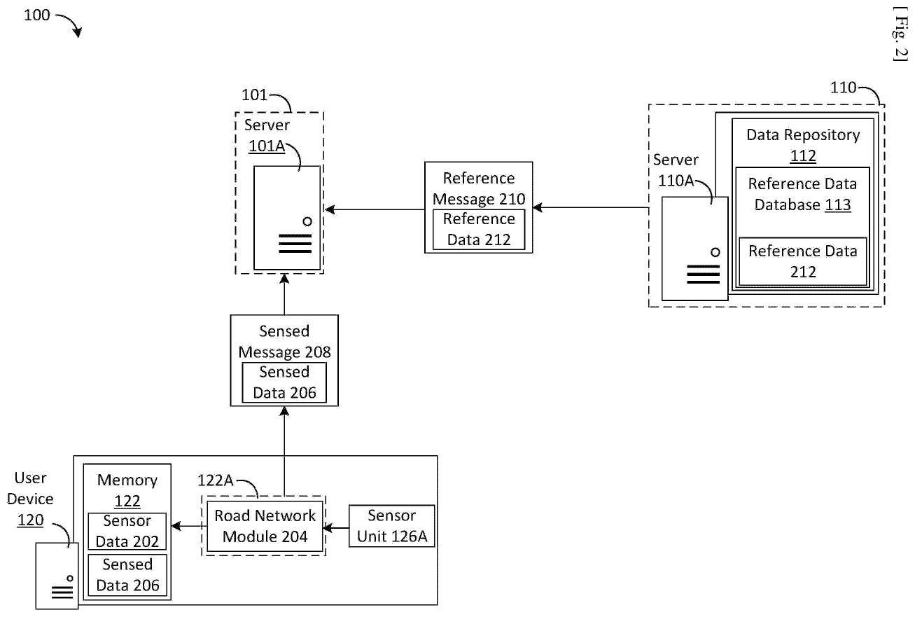

Referring to FIG. 2, user device 120 may include sensor unit 126A. Sensor unit 126A may include multiple sensors. In some examples, the multiple sensors may include a first sensor, such as a light detection and ranging (LIDAR) sensor. The first sensor may be configured to generate sensor data 202 associated with one or more objects within a field of view of the first sensor. The one or more objects may be associated with one or more roads of a road networks, such as signs, trees, rail guards, buildings, traffic lights, street lights, on or near one or more roads of a road network user device 120 may be on. In some instances, sensor data 202 may include timestamp data indicating when each portion of the sensor data was captured/detected by the first sensor. In other examples, the multiple sensors may include a second sensor, such as a monocular camera, configured to generate image data that includes one or more images of an environment within a field of view of the second sensor. In some instances, the one or more images of an environment the user device 1 20 is in, such as a road of a road network. In other instances, the image data may include timestamp data indicating a time and/or date of when each of the one or more images were captured.

As illustrated in FIG. 2, one or more processors of user device 120, such as processor 124, may execute road network module 204 to perform operations to obtain sensor data 202 from a first sensor of sensor unit 126A and generate sensed data 206 based on sensor data 202. For example, executed road network module 204 may determine one or more three-dimensional reference points or positions of each of the one or more objects associated with the one or more roads of a road network user device 120 may be on, based on sensor data 202. Based on the determined three-dimensional reference points or positions of each of the one or more objects, executed road network module 204 may generate sensed data 206 including data identifying one or more three-dimensional data points. As described herein, the one or more three-dimensional data points may each indicate a three-dimensional position of one or more objects associated with one or more roads of a road network.

In some examples, sensed data 206 may include portions of image data including one or more images of the road network user device 120 may be on. As described herein, each of the one or more images may be associated with a portion of the data identifying the one or more three-dimensional data points. For example, executed road network module 204 may obtain the image data along with sensor data 202 from a second sensor of sensor unit 126A and first sensor of sensor unit 126A, respectively. Additionally, executed road network module 204 may determine, for each of the one or more images of the image data and based on the timestamp data of the image data and timestamp data of sensor data 202, corresponding portions of sensor data 202 that have similar or matching timestamps. Moreover, based on such determinations, executed road network module 204 may generate sensed data 206 to also include portions of the obtained image data and data indicating which of the one or more images correspond to or are associated with which three-dimensional data points.

In some instances, executed road network module 204 may store, within memory 122, the generated sensed data 206 (with or without the image data and data indicating which of the one or more images correspond to and are associated with which three-dimensional data points) along with sensor data 202. In other instances, and not illustrated in FIG. 2, executed road network module 204 may store the image data generated by the second sensor of sensor unit 126A within memory 122. Additionally, executed road network module 204 may generate sensed message 208 and package within portions of sensed message 208 one or more portions of sensed data 206. Moreover, executed road network module 204 may transmit sensed message 208 to road network computing system 101.

As illustrated in FIG. 2, one or more processors of server 110A of source computing system 110 may perform operations that obtain reference data 212 from reference data database 113. As described herein, reference data 212 include a set of three-dimensional data points that characterize a high definition three-dimensional map of one or more road networks. The high definition three-dimensional map may be based on sensor data and/or image data generated from one or more sensors of one or more devices, such as one or more vehicles, associated with the source system (e.g., source system 110). Examples of the one or more sensors may include a light detection and ranging (LIDAR) sensor, a radar sensor and/or a camera. In some instances, the three-dimensional data points that make up the high definition three-dimensional map may be more precise than the three-dimensional data points of sensed data 206. In other instances, reference data 212 may include data characterizing one or more road features of one or more roads of each of the road networks characterized by reference data 212. Examples of the one or more road features include, lane markings, the shape of the road and the texture of the road. In various instances, reference data 212 may include data identifying and characterizing one or more objects associated with or near each of the roads of each of the road networks characterized by the reference data. Examples of the one or more objects includes signs (e. g, traffic, commercial, residential, etc.), trees, rail guards, buildings, traffic lights, and street lights. Additionally, the one or more processors of server 110A may generate reference message 210 and package within portions of reference message 210, one or more portions of reference data 212. Further, the one or more processors of server 110A may transmit reference message 210 to road network computing system 101.

Referring to FIG. 3, a programmatic interface established and maintained by road network computing system 101, such as application programming interface (API) 302 may receive sensed message 208 including one or more portions of sensed data 206. As described herein, road network computing system 101 may receive sensed message 208 across communications network 130 via a channel of communications established programmatically between API 302 and executed road network module 204. Additionally, API 302 may receive reference message 210 including one or more portions of reference data 212. As described herein, road network computing system 101 may receive reference message 210 across communications network 130 via a channel of communications established programmatically between API 302 and the one or more processors of server 101A of source computing system 110. Moreover, API 302 may route sensed message 208 and reference message 210 to executed preprocessing engine 106A. Executed preprocessing engine 107A may parse sensed message 208, obtain sensed data 206, and store sensed data 206 within a corresponding portion of data repository 102, such as sensed data database 103. Further, executed preprocessing engine 107A may parse reference message 210, obtain reference data 212, and store reference data 212 within a corresponding portion of data repository 102, such as reference data database 104.

As described herein, executed skeleton engine 107B may obtain sensed data 206 from sensed data database 103 and reference data 212 from reference data database 104. Additionally, executed skeleton engine 107B may generate a sensed skeleton model based on sensed data 206 and a reference skeleton model based on reference data 212. Moreover, executed skeleton engine 107B may generate skeleton data 304 characterizing the reference skeleton model and/or the sensed skeleton model. In some instances, executed skeleton engine 107B may store skeleton data 304 within corresponding portions of data repository 102, such as skeleton data database 105.

For example, executed skeleton engine 107B may extract, from reference data 212, one or more three-dimensional data points of a high definition three-dimensional map of a road network, along with data characterizing one or more road features of one or more roads of the road network. Additionally, executed skeleton engine 107B may apply one or more simplification or abstraction processes to the three-dimensional data points of a high definition three-dimensional map and the corresponding one or more road features. Executed skeleton engine 107B may, based on the application, remove minor details from the road features and/or reduce the number of data points of the obtained three-dimensional data points of a high definition three-dimensional map and the corresponding one or more road features. As such, executed skeleton engine 107B may generate an abstracted or simplified version of the high-definition three-dimensional map, based on the application of the one or more simplification or abstraction processes to the three-dimensional data points and the corresponding one or more road features.

By way of example and referring to FIG. 4A, an example reference road network model 400 may be based on an abstracted or simplified version of the high-definition three-dimensional map of a road network. Additionally, reference road network model 400 may include one or more roads or branches of a road network characterized by the three-dimensional data points of the high definition three-dimensional map and corresponding one or more road features. Moreover, each road or branch may be defined by corresponding road boundaries. For instance, as illustrated in FIG. 4A, a first road or branch may be defined by boundary 402 and 404, a second road may be defined by boundary 406 and boundary 408, a third road may be defined by boundary 410 and boundary 412, and a fourth road may be defined by boundary 414 and boundary 416.

Further, executed skeleton engine 107B may apply one or more skeletonization processes, such as thinning algorithms or a medial axis transform, to the abstracted three-dimensional data points of a high definition three-dimensional map and the corresponding one or more road features. Based on the application of the one or more skeletonization processes to the abstracted three-dimensional data points of a high definition three-dimensional map and the corresponding one or more road features, executed skeleton engine 107B may generate the reference skeleton model. The reference skeleton model may capture the main geometric features of the one or more roads of the road network characterized by the high definition three-dimensional map of reference data 212.

By way of example and referring to FIG. 5A, an example reference skeleton model 500 may be based on the skeletonized three-dimensional data points of the abstracted of a high definition three-dimensional map and corresponding one or more road features of reference road network model 400. Reference skeleton model 500 may include lines or edges representing the roads of reference road network model 400, and nodes representing intersections or junctions of the road network model. For instance, as illustrated in FIG. 5A, reference skeleton model 500 may include lines 502, 504, 506 and 508 and nodes 510, 512 and 514. Line 502 may represent the first road, line 504 may represent the third road, line 506 may represent the second road, and line 508 may represent the fourth road. Additionally, nodes 510, 512 and 514 may each represent an intersection or junction of the road network characterized by reference data 212.

In some instances, executed skeleton engine 107B may implement validation and refinement processes to the generated reference skeleton model. For instance, the validation and refinement process may include comparing the generated reference skeleton model against the high definition three-dimensional map of the reference data. Additionally, the validation and refinement process may include implementing processes to refine the reference skeleton model to ensure its accuracy and completeness in accordance to the three-dimensional data points of the high definition three-dimensional map and corresponding one or more road features included in reference data 212. In other instances, executed skeleton engine 107B may generate skeleton data 304 including data characterizing the reference skeleton model and store the skeleton data within corresponding portions of data repository 102, such as skeleton data database 105.

In another example, based on sensed data 206, executed skeleton engine 107B may generate a three-dimensional map of a road network characterized by sensed data 206. Additionally, and based on sensed data 206, executed skeleton engine 107B may extract one or more road features (e.g., lane markings, the shape of the road and the texture of the road, etc.) associated with one or more roads of the road network characterized by the three-dimensional map. Moreover, executed skeleton engine 107B may apply one or more simplification or abstraction processes to the three-dimensional map and the corresponding one or more road features to remove minor details from the road features and/or reduce the number of data points of the three-dimensional map and the corresponding one or more road features. Based on the application of the one or more simplification or abstraction processes to the three-dimensional data points and the corresponding one or more road features, executed skeleton engine 107B may generate an abstracted or simplified version of the three-dimensional map of sensed data 206.

By way of example and referring to FIG. 4B, an example sensed road network model 420 may be based on the abstracted or simplified version of the three-dimensional map of sensed data 206. Additionally, sensed road network model 420 may include one or more roads or branches of a road network characterized by the three-dimensional data points of the three-dimensional map and corresponding one or more road features. Moreover, each road or branch may be defined by corresponding road boundaries. For instance, as illustrated in FIG. 4B, a fifth road or branch may be defined by boundary 422 and 424, a sixth road or branch may be defined by boundary 426 and boundary 428, a seventh road or branch may be defined by boundary 430 and boundary 432, and an eighth road or branch may be defined by boundary 434 and boundary 436.

Further, executed skeleton engine 107B may apply one or more skeletonization processes, such as thinning algorithms or a medial axis transform, to the three-dimensional data points of the abstracted or simplified version of the three-dimensional map and corresponding one or more road features. Based on the application, executed skeleton engine 107B may generate the sensed skeleton model. The sensed skeleton model may capture the main geometric features of the one or more roads of the road network associated with sensed data 206.

By way of example and referring to FIG. 5B, an example sensed skeleton model 520 may be based on the skeletonized three-dimensional data points of the abstracted or simplified three-dimensional map and corresponding one or more road features of sensed road network model 420. Sensed skeleton model 520 may include lines or edges representing the roads of sensed road network model 420, and nodes representing intersections or junctions of sensed road net work model 420. For instance, as illustrated in FIG. 5B, sensed skeleton model 520 may include lines 522, 524, 526 and 528 and nodes 530, 532 and 534. Line 522 may represent the fifth road, line 524 may represent the seventh road, line 526 may represent the sixth road, and line 528 may represent the eighth road. Additionally, nodes 530, 532 and 534 may each represent an intersection or junction of the road network characterized by sensed data 206.

In some instances, executed skeleton engine 107B may implement validation and refinement processes to the generated sensed skeleton model. For instance, the validation and refinement process may include comparing the generated sensed skeleton model against the three-dimensional map of sensed data 206. Additionally, the validation and refinement process may include implementing processes to refine the sensed skeleton model to ensure its accuracy and completeness in accordance with the three-dimensional data points of the three-dimensional map of sensed data 206 and corresponding one or more road features. In other instances, executed skeleton engine 107B may generate skeleton data 304 including data characterizing the sensed skeleton model. Additionally, executed skeleton engine 107B may store skeleton data 304 within corresponding portions of data repository 102, such as skeleton data database 105.

As illustrated in FIG. 3, executed correspondence engine 107C may obtain skeleton data 304 from skeleton data database 105 and generate, based on skeleton data 304, rough correspondence data 306 and fine correspondence data 308. As described herein, rough correspondence data 306 may identify and characterize which lines or edges of a skeleton model associated with reference data 212, such as the reference skeleton model, corresponds to which lines or edges of a skeleton model associated with sensed data 206, such as the sensed skeleton model. Additionally, fine correspondence data 308 may identify and characterize the point-to-point correspondences between the data points or elements of reference data 212 and the data points or elements of the sensed data 206.

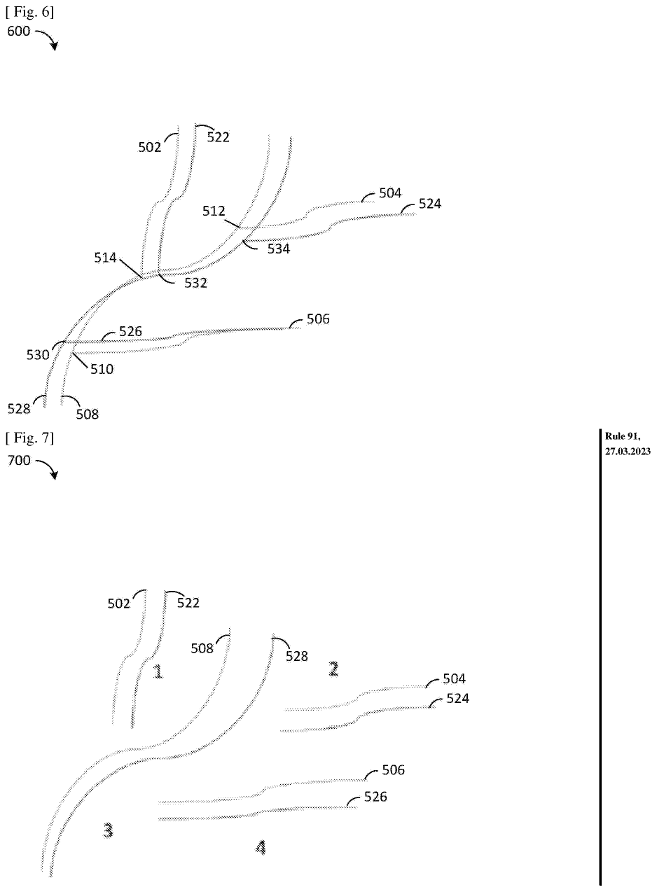

In some examples, executed correspondence engine 107C may perform operations that determine a topology, including nodes, of each of a sensed skeleton model and a reference skeleton model. Additionally, executed correspondence engine 107C may perform operations that utilize the topologies of the sensed skeleton model and reference skeleton model, such as the nodes included in the topologies, to determine which lines or edges of the sensed skeleton model corresponds to which lines or edges of the reference skeleton model. For example, for the sensed skeleton model, executed correspondence engine 107C may identify one or more nodes included in the sensed skeleton model. Additionally, for the reference skeleton model, executed correspondence engine 107C may identify one or more nodes included in the reference skeleton model. Moreover, based on the one or more identified nodes of the sensed skeleton model and the one or more identified nodes of the reference skeleton model, executed correspondence engine 107C may determine one or more node correspondences between the sensed skeleton model and the reference skeleton model. For instance, executed correspondence engine 107C may determine, for each identified node of the sensed skeleton model, a corresponding identified node of the reference skeleton model. By way of example, and referring to FIG. 5A and FIG. 5B, reference skeleton model 500 may include lines 502, 504, 506 and 508 and nodes 510, 512 and 514 and sensed skeleton model 520 may include lines 522, 524, 526 and 528 and nodes 530, 532 and 534. Additionally, executed correspondence engine 107C may utilize corresponding three-dimensional reference points or positions of each node to determine, for each node of the reference skeleton model 500, a corresponding node of sensed skeleton model 520. For instance, a node of reference skeleton model 500 may correspond to a node of sensed skeleton model 520 with the most similar three-dimensional reference point or position. Referring to FIG. 6, node 510 of reference skeleton model 500 may correspond to node 530 of sensed skeleton model 520, node 512 of reference skeleton model 500 may correspond to node 534 of sensed skeleton model 520, and node 514 of reference skeleton model 500 may correspond to node 532 of sensed skeleton model 520.

Moreover, based on the determined node correspondences, executed correspondence engine 107C may determine one or more line or edge correspondences between the sensed skeleton model and the reference skeleton model. For instance, executed correspondence engine 107C may determine, for each line or edge of the sensed skeleton model, a corresponding line or edge of the reference skeleton model. By way of example and referring back to FIG. 6, executed correspondence engine 107C may utilize the determined node correspondences to determine, for each line of reference skeleton model 500, a corresponding line of sensed skeleton model 520. As illustrated in FIG. 6, executed correspondence engine 107C may determine line or edge 502 of reference skeleton model may correspond to line or edge 522 of sensed skeleton model, line or edge 504 of reference skeleton model may correspond to line or edge 524 of sensed skeleton model, line or edge 506 of reference skeleton model may correspond to line or edge 526 of sensed skeleton model, and line or edge 508 of reference skeleton model may correspond to line or edge 528 of sensed skeleton model 520.

Further, based on the determined line or edge correspondence(s), executed correspondence engine 107C may generate rough correspondence data 306 characterizing each determined line or edge correspondence. As described herein rough correspondence data may characterize, for each line or edge of the sensed skeleton model, a determined corresponding line or edge of the reference skeleton model. In some instances, executed correspondence engine 107C may store the generated rough correspondence data 306 within corresponding portions of data repository 102, such as correspondence data database 106.

As illustrated in FIG. 3, executed correspondence engine 107C may perform operations that utilize rough correspondence data 306 to generate fine correspondence data 308. As described herein, fine correspondence data 308 may identify and characterize, for each line or edge correspondence, one or more point-to-point correspondences. Each point-to-point correspondence may identify and characterize a three-dimensional data point of a high definition three-dimensional map of a road network characterized by reference data 212 and a corresponding three-dimensional data point of a three-dimensional map of a road network characterized by sensed data 206. In such examples, executed correspondence engine 107C may determine, for each line or edge correspondence, one or more point-to-point correspondences based on corresponding portions of reference data 212 and corresponding portions of sensed data 206. Additionally, each of the corresponding portions of reference data 212 may characterize a corresponding portion of the high definition three-dimensional map and associated three-dimensional data points. Moreover, each of the corresponding portions of sensed data 206 may characterize a corresponding portion of the three-dimensional map and associated three-dimensional data points. In some instances, executed correspondence engine 107C may generate fine correspondence data 308 characterizing the determined point-to-point correspondences for each of the line/edge correspondences. In other instances, executed correspondence engine 107C may store fine correspondence data 308 for each of the line/edge correspondences, within corresponding portions of data repository 102, such as correspondence data database 106.

By way of example, executed correspondence engine 107C may obtain rough correspondence data 306 that may characterize multiple the line/edge correspondences. For instances, as illustrated in FIG. 7 a first portion of rough correspondence data 306 may correspond to a line or edge correspondence between line 502 and line 522, a second portion of rough correspondence data 306 may correspond to a line or edge correspondence between line 504 and line 524, a third portion of rough correspondence data 306 may correspond to a line or edge correspondence between line 508 and line 528, and a fourth portion of rough correspondence data 306 may correspond to a line or edge correspondence between line 506 and line 526. Additionally, executed correspondence engine 107C may determine point-to-point correspondences for each of the determined line or edge correspondences of a road network as characterized by rough correspondence data 306. For instance, for the line or edge correspondence between line 502 and line 522, executed correspondence engine 107C may obtain portions of sensed data 206 corresponding to line 522 from sensed data database 103 and portions of reference data 212 corresponding to line 502 from reference data database 104. As described herein, the obtained portion of sensed data 206 may characterize a portion of a three-dimensional map and associated three-dimensional data points corresponding to line 522, while the obtained portion of reference data 212 may characterize a portion of a high definition three-dimensional map and associated three-dimensional data points corresponding to line 502.

Moreover, executed correspondence engine 107C may apply one or more processes to the obtained portion of reference data and the obtained portion of sensed data. Based on the application of the one or more processes to the obtained portion of reference data 212 and the obtained portion of sensed data 206, executed correspondence engine 107C may determine one or more point-to-point correspondences. Each determined point-to-point correspondence may identify and characterize a three-dimensional data point of the obtained portion of reference data 212 and a corresponding three-dimensional data point of the obtained portion of sensed data 206.

Further, executed correspondence engine 107C may apply one or more additional processes, such as a sliding window process, to each determined point-to-point correspondence. Based on the application of the one or more additional processes to each determined point-to-point correspondence, executed correspondence engine 107C may determine a difference or deviation of each point-to-point correspondence (e.g., a difference between the three-dimensional data point of the portion of reference data and corresponding three-dimensional data point of the portion of the sensed data). Each determined deviation or difference may be represented by a value or deviation value. In some instances, executed correspondence engine 107C may generate, for each line/edge correspondence, fine correspondence data 308 characterizing the determine point-to-point correspondences along with the associated deviation value. In such instances, executed correspondence engine 107C may store the fine correspondence data 308 within corresponding portions of data repository 102, such as correspondence data database 106.

In examples where executed correspondence engine 107C applies a sliding window process to each determined point-to-point correspondence, each window applied to a portion of a particular edge/line correspondence may result in multiple deviation values for each point-to-point correspondence. In such examples, executed correspondence engine 107C may implement a voting process to determine which of the multiple difference/deviation values to utilize and include in the fine correspondence data of a particular line/edge correspondence. In some instances, executed correspondence engine 107C may utilize, for a particular point-to-point correspondence, a deviation value that has the highest score representing the smallest deviation.

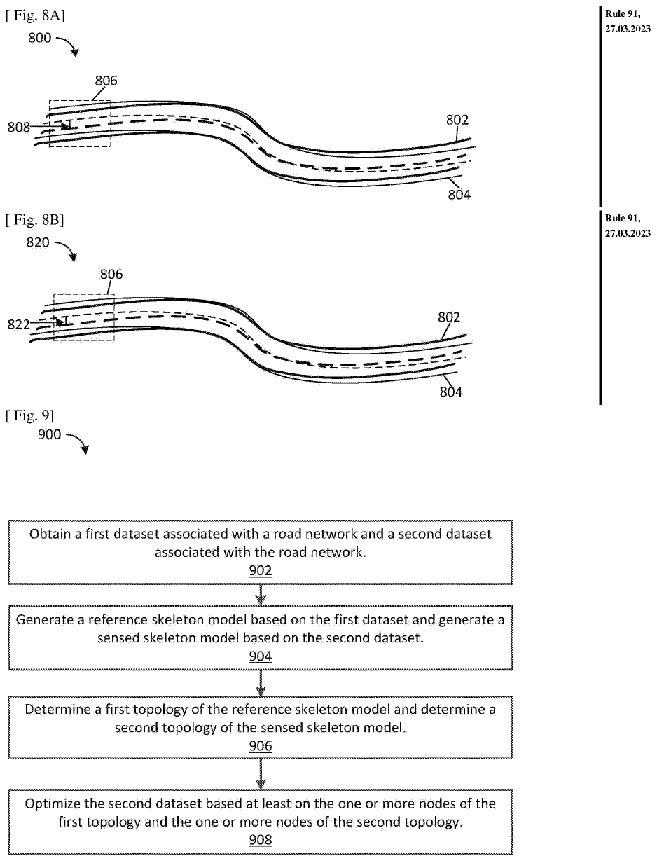

By way of example and referring to FIG. 8A and FIG. 8B, example portions of three-dimensional map 802 and 804 may be based on sensed data and reference data respectively. Further, the portion of three-dimensional map 802 and portion of three-dimensional map 804 may correspond to a portion of a line or edge correspondence between a sensed skeleton model and a reference skeleton model, such as the line or edge correspondence between line 502 and line 522 as illustrated in FIG. 6. The portion of three-dimensional map 802 may correspond to portions of sensed data 206, while the portion of three-dimensional map 804 may correspond to portions of reference data 212. As described herein, the portion of sensed data 206 may characterize a portion of a three-dimensional map and associated three-dimensional data points, while the portion of reference data 212 may characterize a portion of a high definition three-dimensional map and associated three-dimensional data points corresponding to line 502.

Additionally, as illustrated in FIG. 8A and FIG. 8B, a sliding window may be applied to portions of the portions of three-dimensional map 802 and 804 and executed correspondence engine 107C may determine deviations or differences between one or more point-to-point correspondences within the window. For example, as illustrated in FIG. 8A, at a first time interval, window 806 may be at a first position on the portions of three-dimensional map 802 and 804. Additionally, executed correspondence engine 107C, may determine, for one or more point-to-point correspondences within window 806, such as point-to-point correspondence 808, a particular difference or deviation value between the corresponding three-dimensional data point of sensed data 206 and corresponding three-dimensional data point of reference data 212. Moreover, and as illustrated in FIG. 8B, at a second time interval, window 806 may be shifted or applied at a second position on the portions of three-dimensional map 802 and 804. While window 806 is in the second position, executed correspondence engine 107C, may determine, for one or more point-to-point correspondences within window 806 at the second position, a particular difference or deviation value between the corresponding three-dimensional data point of sensed data 206 and corresponding three-dimensional data point of reference data 212. Given the overlap of window 806 in the first position and the second position, executed correspondence engine 107C may have determined, for one or more of the point-to-point correspondences, multiple difference or deviation values between the corresponding three-dimensional data point of sensed data 206 and corresponding three-dimensional data point of reference data 212. For instance, as illustrated in FIG. 8B, the point-to-point correspondence 822 may be the same as the point-to-point correspondence 808 of FIG. 8A. Additionally, point-to-point correspondence 808 and point-to-point correspondence 822 may each have a different determined difference or deviation value. As such, as described herein, executed correspondence engine 107C may implement a voting process to determine which of the multiple difference/deviation values to utilize for optimizing sensed data 206.

Referring back to FIG. 3, executed optimization engine 107D may perform operations that utilize fine correspondence data 308 to optimize sensed data 206. As described herein, Additionally, executed optimization engine 107D may optimize sensed data 206 to minimize the deviation between the three-dimensional data points of sensed data 206 and three-dimensional data points of reference data 212. As described herein, the three-dimensional data points of sensed data 206 may characterize a three-dimensional map of a road network. Moreover, executed optimization engine 107D may optimize the three-dimensional data points of the sensed data to minimize the deviation between the three-dimensional data points of sensed data 206 and three-dimensional data points of reference data 212 by rotating and/or translating the three-dimensional data points without altering the overall shape and formation of the three-dimensional data points. In some examples, executed optimization engine 107D may utilize a rotation and translation matrix to optimize sensed data 206. In other examples, executed optimization engine 107D may iteratively rotate and/or translate sensed data 206. Additionally, executed optimization engine 107D may determine, for each iteration, a deviation value for each point-to-point correspondence and determine an average deviation value or aggregate deviation value. Based on the average or aggregate deviation value of each iteration, executed optimization engine 107D may determine an iteration that has the smallest overall deviation between sensed data 206 and reference data 212. In some instances, executed optimization engine may generate optimized sensed data 310 and store the optimized sensed data 310 in corresponding portions of data repository 102, such as sensed data database 103. In other instances, executed optimization engine may transmit optimized sensed data 310 to user device 120. User device 120 may utilize optimized sensed data 310 for navigation or mapping purposes instead of sensed data 206. For instance, user device 120 may, based on the optimized sensed data 310, update one or more navigation processes, such as mapping data stored on user device 120. As described herein, mapping data may be associated with one or more road networks and may characterize one or more roads of each of the one or more road networks. Additionally, mapping data may be based on sensor data generated by one or more sensors of user device 120 and/or sensed data. Moreover, user device 120 may utilize the mapping data for navigation purposes.

FIG. 9 is a flowchart of an exemplary process 900 for optimizing sensed data obtained from user device 120, in accordance with some exemplary embodiments. For example, road network computing system 101 may perform one or more of the steps of exemplary process 900, as described below in reference to FIG. 9. Referring to FIG. 9, road network computing system 101 may perform any of the processes described herein to obtain a first dataset associated with a road network and a second dataset associated with the road network (e.g., in step 902 of FIG. 9). In some examples, road network computing system 101 may obtain the first dataset or reference data from one or more source computing systems, such as source computing system 110. The first dataset or reference data may include a set of three-dimensional data points that characterize a high definition three-dimensional map of one or more road networks. The high definition three-dimensional map may be based on sensor data and/or image data generated from one or more sensors of one or more devices, such as one or more vehicles, associated with the source system (e.g., source system 110). Examples of the one or more sensors may include a light detection and ranging (LIDAR) sensor, a radar sensor and/or a camera.

In other examples, road network computing system 101 may obtain the second dataset or sensed data from user device 120. In various examples, road network computing system 101 may implement operations described herein that generate the second dataset or sensed data based on sensor data and/or image data of one or more roads of the road network from user device 120. The second dataset or sensed data may include data identifying one or more three-dimensional data points. Each of the one or more three-dimensional data points may characterize a three-dimensional position or reference point of one or more objects within a field of view of a sensor, such as a light detection and ranging (LIDAR) sensor, operatively or communicatively coupled to user device 120. The one or more objects may be associated with one or more roads of a road networks, such as signs, trees, rail guards, buildings, traffic lights, street lights, on or near one or more roads of a road network user device 120, such as a vehicle, may be traveling on. In some instances, the sensed data may include image data including one or more images that are each associated with a portion of the data identifying the one or more three-dimensional data points. In some instances, the three-dimensional data points that make up the high definition three-dimensional map of the reference data may be more precise than the three-dimensional data points of the sensed data.

Referring back to FIG. 9, road network computing system 101 may perform any of the processes described herein to generate a reference skeleton model based on the first dataset and generate a sensed skeleton model based on the second dataset (e.g., in step 904 of FIG. 9). In examples where executed skeleton engine 107B generates a reference skeleton model based on the first dataset, executed skeleton engine 107B may extract from the first dataset, one or more three-dimensional data points of a high definition three-dimensional map of a road network, along with data characterizing one or more road features of one or more roads of the road network. Additionally, executed skeleton engine 107B may apply one or more simplification or abstraction processes to the three-dimensional data points of a high definition three-dimensional map and the corresponding one or more road features. Executed skeleton engine 107B may, based on the application, remove minor details and reduce the number of data points of the obtained three-dimensional data points of a high definition three-dimensional map and the corresponding one or more road features. As such, executed skeleton engine 107B may generate an abstracted or simplified version of the high-definition three-dimensional map, based on the application.

Moreover, executed skeleton engine 107B may apply one or more skeletonization processes, such as thinning algorithms or a medial axis transform, to the abstracted three-dimensional data points of a high definition three-dimensional map and the corresponding one or more road features. Based on the application of the one or more skeletonization processes to the abstracted three-dimensional data points of a high definition three-dimensional map and the corresponding one or more road features, executed skeleton engine 107B may generate the reference skeleton model. The skeleton model may capture the main geometric features of the one or more roads of the road network characterized by the high definition three-dimensional map of reference data 212.

In examples where executed skeleton engine 107B generates a sensed skeleton model based on the second dataset, executed skeleton engine 107B may generate a three-dimensional map of a road network characterized by the sensed data. Additionally, and based on the sensed data, executed skeleton engine 107B may extract one or more road features (e.g., lane markings, the shape of the road and the texture of the road, etc.) associated with one or more roads of the road network characterized by the three-dimensional map. Moreover, executed skeleton engine 107B may apply one or more simplification or abstraction processes to the three-dimensional map and the corresponding one or more road features to remove minor details and reduce the number of data points of the three-dimensional map and the corresponding one or more road features. Based on the application, executed skeleton engine 107B may generate an abstracted or simplified version of the three-dimensional map of the sensed data.

Further, executed skeleton engine 107B may apply one or more skeletonization processes, such as thinning algorithms or a medial axis transform, to the three-dimensional data points of the abstracted or simplified version of the three-dimensional map and corresponding one or more road features. Based on the application, executed skeleton engine 107B may generate the sensed skeleton model. The sensed skeleton model may capture the main geometric features of the one or more roads of the road network associated with the sensed data.

Referring back to FIG. 9, road network computing system 101 may perform any of the processes described herein to determine a first topology of the reference skeleton model and determine a second topology of the sensed skeleton model (e.g., in step 906 of FIG. 9). Further, road network computing system 101 may perform any of the processes described herein to optimize the second dataset based at least on one or more nodes of the first topology and one or more nodes of the second topology (e.g., in step 908 of FIG. 9). For example, executed correspondence engine 107C may perform operations that identify nodes or determine a topology of a sensed skeleton model and a reference skeleton model. Additionally, executed correspondence engine 107C may perform operations that utilize the identified nodes or determined topology to determine one or more node correspondences between the reference skeleton model and the sensed skeleton model. Based on the determined one or more node correspondences, executed correspondence engine 107C may determine one or more line or edge correspondences between the sensed skeleton model and the reference skeleton model. Moreover, for each line or edge correspondence, executed correspondence engine 107C may utilize corresponding portions of reference data and corresponding portions of sensed data to determine point-to-point correspondences between the corresponding portions of reference data and corresponding portions of sensed data. Further, executed correspondence engine 107C may apply one or more additional processes, such as a sliding window process, to each determined point-to-point correspondence. Based on the application of the one or more additional processes to each determined point-to-point correspondence, executed correspondence engine 107C may determine a difference or deviation of each point-to-point correspondence (e.g., a difference between the three-dimensional data point of the portion of reference data and corresponding three-dimensional data point of the portion of the sensed data). As described herein, each determined deviation or difference may be represented by a value or deviation value.

Additionally, executed optimization engine 107D may perform operations that utilize the determine deviations or differences of each point-to-point correspondence to optimize the sensed data. Executed optimization engine 107D may optimize the sensed data to minimize the deviation between the three-dimensional data points of the sensed data and three-dimensional data points of the reference data. Moreover, the three-dimensional data points of the sensed data may characterize a three-dimensional map of a road network. Further, executed optimization engine 107D may optimize the three-dimensional data points of the sensed data to minimize the deviation between the three-dimensional data points of the sensed data and three-dimensional data points of the reference data by rotating and/or translating the three-dimensional data points without altering the overall shape and formation of the three-dimensional data points. In some examples, executed optimization engine 107D may utilize a rotation and translation matrix to optimize the sensed data. In other examples, executed optimization engine 107D may iteratively rotate and/or translate the sensed data. Additionally, executed optimization engine 107D may determine, for each iteration, a deviation value for each point-to-point correspondence and determine an average deviation value or aggregate deviation value. Based on the average or aggregate deviation value of each iteration, executed optimization engine 107D may determine an iteration that has the smallest overall deviation between the sensed data and the reference data. That iteration may be transmitted to user device 120.

In some instances, executed optimization engine 107D may generate the optimized sensed data and transmit optimized sensed data to user device 120. User device 120 may utilize optimized sensed data 310 for navigation or mapping purposes instead of the sensed data originally transmitted to road network computing system 101. In examples where user device 120 is a vehicle, such as an autonomous vehicle, the vehicle or user device 120 may utilize the optimized sensed data 310 to adjust one or more operating parameters associated with the vehicle. Examples of the one or more operating parameters includes path planning parameters, lane centering parameters, lane selection parameters, and speed adjustment parameters. For example, executed optimization engine 107D may generate the optimized sensed data and transmit optimized sensed data to user device 120. User device 120 may update mapping data based on optimized sensed data 310. Based on the updated mapping data, user device 120 may adjust one or more operating parameters associated with user device 120 (e.g., a lane selection parameter).

Implementation examples are further described in the following numbered clauses:
1. An apparatus comprising:
   a memory; and
   at least one processor coupled to the memory, the at least one processor configured to:
      generate a reference skeleton model based on a first dataset;
      obtain a second dataset associated with the road network;
      generate a sensed skeleton model based on the second dataset;
      determine a first topology of the reference skeleton model and a second topology of the sensed skeleton model, the first topology and the second topology each identifying and characterizing one or more nodes; and
      based at least on the one or more nodes of the first topology and the one or more nodes of the second topology, perform operations that adjust a positioning of one or more data points of the second dataset.
2. The apparatus of clause 1, wherein the at least one processor is further configured to update one or more navigation processes of a user device, the one or more navigation processes including updating mapping data.
3. The apparatus of clause 2, wherein the at least one processor is further configured to adjust an operating parameter of a vehicle based on the adjusted second dataset.
4. The apparatus of any of clauses 1-3, wherein the first topology and the second topology each further identify one or more lines, and wherein the at least one processor is further configured to:
   determine one or more line correspondences between the reference skeleton model and the sensed skeleton model based at least on the first topology and the second topology;
   for each of the one or more line correspondences, determine one or more point-to-point correspondences between corresponding portions of the first dataset and corresponding portions of the second dataset;
   for each of the one or more point-to-point correspondences, determine a deviation value; and
   perform the operations that adjust the positioning of the one or more data points of the second dataset based at least on the deviation value of each of the one or more point-to-point correspondences.
5. The apparatus of clause 4, wherein the at least one processor is configured to apply a sliding window process to corresponding portions of the first dataset and the second dataset to determine the deviation value of each of the one or more point-to-point correspondences.
6. The apparatus of any of clauses 1-5, wherein the first dataset includes a set of three-dimensional data points that characterize a three-dimensional map of the road network.
7. The apparatus of any of clauses 1-6, wherein the at least one processor is configured to obtain the first dataset from another computing system.
8. The apparatus of any of clauses 1-7, wherein the second dataset includes data characterizing a set of three dimensional data points associated with the road network.
9. The apparatus of clause 8, wherein the second dataset is based on sensor data.
10. The apparatus of clause 9, further comprising one or more sensors, wherein the sensor data is generated from the one or more sensors, and wherein the at least one processor is configured to receive the sensor data from the one or more sensors and generate the second dataset based on the sensor data.
11. The apparatus of clause 10, wherein the one or more sensors include a LIDAR sensor.
12. The apparatus of clause 11, wherein the apparatus is a vehicle, and wherein the apparatus includes the one or more sensors.
13. The apparatus of clause 11, wherein the at least one processor is configured to obtain the second dataset from a vehicle including the one or more sensors.
14. The apparatus of any of clauses 1-13, wherein the at least one processor is further configured to:
   transmit the adjusted second dataset a computing device of a vehicle.
15. The apparatus of any of clauses 1-14, wherein the at least one processor is further configured to:
   rotate the one or more data points of the second dataset to adjust the positioning of the one or more data points of the second dataset.
16. The apparatus of any of clauses 1-15, wherein the at least one processor is further configured to:
   translate the one or more data points of the second dataset to adjust the positioning of the one or more data points of the second dataset.
17. The apparatus of any of clauses 1-16, wherein the at least one processor is further configured to:
   determine, for at least a first data point and a second data point of the second data set, a distance and a relative angle between the first data point and the second data point; and
   adjust the positioning of at least the first data point and the second data point based on the determined distance and relative angle between the first data point and the second data point and the one or more nodes of the first topology and the one or more nodes of the second topology.
18. The apparatus of clause 17, wherein the at least one processor is further configured to:
   adjust the positioning of at least the first data point and the second data point without adjusting the determined distance and relative angle between the first data point and the second data point.
19. An apparatus comprising:
   a memory; and
   at least one processor coupled to the memory, the at least one processor configured to:
      generate a reference skeleton model based on a first dataset;
      obtain a second dataset associated with the road network and data generated by one or more sensors;
      generate a sensed skeleton model based on the second dataset;
      determine a first topology of the reference skeleton model and a second topology of the sensed skeleton model, the first topology and the second topology each identifying and characterizing one or more nodes; and
      based at least on the one or more nodes of the first topology and the one or more nodes of the second topology, perform operations that adjust a positioning of one or more data points of the second dataset.
20. The apparatus of clause 19, wherein the data generated by the one or more sensors includes image data, the image data including one or more two-dimensional images.
21. The apparatus of clause 20, wherein the one or more sensors includes an image sensor and the image data is generated by the image sensor.
22. The apparatus of clause 21, wherein the data generated by the one or more sensors includes sensor data, the sensor data indicating a three-dimensional position of each of one or more objects associated with the road network.
23. The apparatus of clause 22, wherein the one or more sensors includes a LIDAR sensor, and the sensor data is generated by the LIDAR sensor.
24. The apparatus of clause 23, further comprising the one or more sensors, and wherein the at least one processor is configured to receive the sensor data and the image data from the one or more sensors and generate the second dataset based on the sensor data and the image data.
25. The apparatus of clause 21, further comprising the one or more sensors, and wherein the at least one processor is configured to receive the image data from the one or more sensors and generate the second dataset based on the image data.
26. The apparatus of clause 19, wherein the data generated by the one or more sensors includes sensor data, the sensor data indicating a three-dimensional position of each of one or more objects associated with the road network.
27. The apparatus of clause 26, further comprising the one or more sensors, wherein the one or more sensors includes a LIDAR sensor and the LIDAR sensor generates the sensor data, and wherein the at least one processor is configured to receive the sensor data from the one or more sensors and generate the second dataset based on the sensor data.
28. The apparatus of any of clauses 19-27, wherein the apparatus is a vehicle, and wherein the apparatus includes the one or more sensors.
29. The apparatus of any of clauses 19-27, wherein the at least one processor is configured to obtain the second dataset from a vehicle including the one or m ore sensors.
30. The apparatus of any of clauses 19-29, wherein the at least one processor is further configured to transmit the adjusted second dataset a computing device of a vehicle.
31. The apparatus of any of clauses 19-30, wherein the at least one processor is further configured to update one or more navigation processes of a user device, the one or more navigation processes including updating mapping data.
32. The apparatus of clause 31, wherein the at least one processor is further configured to adjust an operating parameter of a vehicle based on the adjusted second dataset.
33. The apparatus of any of clauses 19-32, wherein the first topology and the second topology each further identify one or more lines, and wherein the at least one processor is further configured to:
   determine one or more line correspondences between the reference skeleton model and the sensed skeleton model based at least on the first topology and the second topology;
   for each of the one or more line correspondences, determine one or more point-to-point correspondences between corresponding portions of the first dataset and corresponding portions of the second dataset;
   for each of the one or more point-to-point correspondences, determine a deviation value; and
   perform the operations that adjust the positioning of the one or more data points of the second dataset based at least on the deviation value of each of the one or more point-to-point correspondences.
34. The apparatus of clause 33, wherein the at least one processor is configured to apply a sliding window process to corresponding portions of the first dataset and the second dataset to determine the deviation value of each of the one or more point-to-point correspondences.
35. The apparatus of any of clauses 19-34, wherein the first dataset includes a set of three-dimensional data points that characterize a three-dimensional map of the road network.
36. The apparatus of clause 19-35, wherein the at least one processor is configured to obtain the first dataset from another computing system.
37. A non-transitory, machine-readable storage medium storing instructions that, when executed by at least one processor of a server, causes the at least one processor to perform operations that include:
   generating a reference skeleton model based on a first dataset;
   obtaining a second dataset associated with the road network;
   generating a sensed skeleton model based on the second dataset;
   determining a first topology of the reference skeleton model and a second topology of the sensed skeleton model, the first topology and the second topology each identifying and characterizing one or more nodes; and
   based at least on the one or more nodes of the first topology and the one or more nodes of the second topology, performing operations that adjust a positioning of one or more data points of the second dataset.
38. The non-transitory, machine-readable storage medium of clause 37, wherein the at least one processor performs operations that include updating one or more navigation processes of a user device, the one or more navigation processes including updating mapping data.
39. The non-transitory, machine-readable storage medium of clause 38, wherein the at least one processor performs operations that include adjusting an operating parameter of a vehicle based on the adjusted second dataset.
40. The non-transitory, machine-readable storage medium of clauses 37-39, wherein the first topology and the second topology each further identify one or more lines, and wherein the at least one processor performs operations that include:
   determining one or more line correspondences between the reference skeleton model and the sensed skeleton model based at least on the first topology and the second topology;
   for each of the one or more line correspondences, determining one or more point-to-point correspondences between corresponding portions of the first dataset and corresponding portions of the second dataset;
   for each of the one or more point-to-point correspondences, determining a deviation value; and
   performing the operations that adjust the positioning of the one or more data points of the second dataset based at least on the deviation value of each of the one or more point-to-point correspondences.
41. The non-transitory, machine-readable storage medium of clause 40, wherein the at least one processor performs operations that include applying a sliding window process to corresponding portions of the first dataset and the second dataset to determine the deviation value of each of the one or more point-to-point correspondences.
42. The non-transitory, machine-readable storage medium of any of clauses 37-41, wherein the first dataset includes a set of three-dimensional data points that characterize a three-dimensional map of the road network.
43. The non-transitory, machine-readable storage medium of any of clauses 37-42, wherein the at least one processor performs operations that include obtaining the first dataset from another computing system.
44. The non-transitory, machine-readable storage medium of any of clauses 37-43, wherein the second dataset includes data characterizing a set of three dimensional data points associated with the road network.
45. The non-transitory, machine-readable storage medium of clause 44, wherein the second dataset is based on sensor data.
46. The non-transitory, machine-readable storage medium of clause 45, further comprising one or more sensors, wherein the sensor data is generated from the one or more sensors, and wherein the at least one processor performs operations that include receiving the sensor data from the one or more sensors and generate the second dataset based on the sensor data.
47. The non-transitory, machine-readable storage medium of clause 46, wherein the one or more sensors include a LIDAR sensor.
48. The non-transitory, machine-readable storage medium of clause 47, wherein the apparatus is a vehicle, and wherein the apparatus includes the one or more sensors.
49. The non-transitory, machine-readable storage medium of clause 48, wherein the at least one processor is configured to obtain the second dataset from a vehicle including the one or more sensors.
50. The non-transitory, machine-readable storage medium of any of clauses 37-49, wherein the at least one processor performs operations that include:
   transmitting the adjusted second dataset a computing device of a vehicle.
51. The non-transitory, machine-readable storage medium of any of clauses 37-50, wherein the at least one processor performs operations that include:
   rotating the one or more data points of the second dataset to adjust the positioning of the one or more data points of the second dataset.
52. The non-transitory, machine-readable storage medium of any of clauses 37-51, wherein the at least one processor performs operations that include:
   translating the one or more data points of the second dataset to adjust the positioning of the one or more data points of the second dataset.
53. The non-transitory, machine-readable storage medium of any of clauses 37-52, wherein the at least one processor performs operations that include:
   determining, for at least a first data point and a second data point of the second dataset, a distance and a relative angle between the first data point and the second data point; and
   adjusting the positioning of at least the first data point and the second data point based on the determined distance and relative angle between the first data point and the second data point and the one or more nodes of the first topology and the one or more nodes of the second topology.
54. The non-transitory, machine-readable storage medium of clause 53, wherein the at least one processor performs operations that include:
   adjusting the positioning of at least the first data point and the second data point without adjusting the determined distance and relative angle between the first data point and the second data point.
55. A computer-implemented method performed by an application program executed on at least one processor of a vehicle, the computer-implemented method comprising:
   generating a reference skeleton model based on a first dataset;
   obtaining a second dataset associated with the road network;
   generating a sensed skeleton model based on the second dataset;
   determining a first topology of the reference skeleton model and a second topology of the sensed skeleton model, the first topology and the second topology each identifying and characterizing one or more nodes; and
   based at least on the one or more nodes of the first topology and the one or more nodes of the second topology, performing operations that adjust a positioning of one or more data points of the second dataset.
56. The computer-implemented method of clause 55 further comprises:
   updating one or more navigation processes of a user device, the one or more navigation processes includes updating mapping data.
57. The computer-implemented method of clause 56, further comprises:
   adjusting an operating parameter of a vehicle based on the adjusted second dataset.
58. The computer-implemented method of any of clauses 55-57, wherein the first topology and the second topology each further identifying one or more lines, and wherein the computer-implemented method further comprises:
   determining one or more line correspondences between the reference skeleton model and the sensed skeleton model based at least on the first topology and the second topology;
   for each of the one or more line correspondences, determining one or more point-to-point correspondences between corresponding portions of the first dataset and corresponding portions of the second dataset;
   for each of the one or more point-to-point correspondences, determining a deviation value; and
   performing operations that adjust the positioning of the one or more data points of the second dataset, based at least on the deviation value of each of the one or more point-to-point correspondences.
59. The computer-implemented method of clause 58, wherein determining the deviation value of each of the one or more point-to-point correspondences includes applying a sliding window process to corresponding portions of the first dataset and the second dataset.
60. The computer-implemented method of any of clauses 55-59, wherein the first dataset includes a set of three-dimensional data points that characterize a three-dimensional map of the road network.
61. The computer-implemented method of any of clauses 55-60, further comprising:
   obtaining the first dataset from another computing system.
62. The computer-implemented method of any of clauses 55-61 wherein the second dataset includes data characterizing a set of three dimensional data points associated with the road network.
63. The computer-implemented method of clause 62, wherein the second dataset is based on sensor data.
64. The computer-implemented method of clause 63, further comprising:
   receiving the sensor data from one or more sensors; and
   generating the second dataset based on the sensor data.
65. The computer-implemented method of clause 64, wherein the one or more sensors includes a LIDAR sensor.
66. The computer-implemented method of clause 65, wherein the one or more sensors are communicatively coupled to a vehicle.
67. The computer-implemented method of clause 66, further comprising:
   obtaining the second dataset from a vehicle including the one or more sensors.
68. The computer-implemented method of any of clauses 55-67, further comprising:
   transmitting the optimized second dataset a computing device of a vehicle.
69. The computer-implemented method of clauses 55-68, wherein the first dataset is based on sensor data of a plurality of devices.
70. The computer-implemented method of clauses 55-69, further comprising:
   rotating the one or more data points of the second dataset to adjust the positioning of the one or more data points of the second dataset.
71. The computer-implemented method of clauses 55-70, further comprising:
   translating the one or more data points of the second dataset to adjust the positioning of the one or more data points of the second dataset.
72. The computer-implemented method of clauses 55-71, further comprising:
   determining, for at least a first data point and a second data point of the second dataset, a distance and a relative angle between the first data point and the second data point; and
   adjusting the positioning of at least the first data point and the second data point based on the determined distance and relative angle between the first data point and the second data point and the one or more nodes of the first topology and the one or more nodes of the second topology.
73. The computer-implemented method of clause 72, further comprising:
   adjusting the positioning of at least the first data point and the second data point without adjusting the determined distance and relative angle between the first data point and the second data point.

### C. Exemplary Hardware and Software Implementations:

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including preprocessing engine 107A, skeleton engine 107B, correspondence engine 107C, optimization engine 107D, application 122A, road network module 204, and application programming interface (API) 302 can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, an application program, an engine, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as a user operating user device 120, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network.

Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

1. An apparatus comprising:
a memory; and
at least one processor coupled to the memory, the at least one processor configured to:
generate a reference skeleton model based on a first dataset;
obtain a second dataset associated with the road network;
generate a sensed skeleton model based on the second dataset;
determine a first topology of the reference skeleton model and a second topology of the sensed skeleton model, the first topology and the second topology each identifying and characterizing one or more nodes; and
based at least on the one or more nodes of the first topology and the one or more nodes of the second topology, perform operations that adjust a positioning of one or more data points of the second dataset.

2. The apparatus of claim 1, wherein the at least one processor is further configured to update one or more navigation processes of a user device, the one or more navigation processes including updating mapping data.

3. The apparatus of claim 2, wherein the at least one processor is further configured to adjust an operating parameter of a vehicle based on the adjusted second dataset.

4. The apparatus of claim 1, wherein the first topology and the second topology each further identify one or more lines, and wherein the at least one processor is further configured to:
determine one or more line correspondences between the reference skeleton model and the sensed skeleton model based at least on the first topology and the second topology;
for each of the one or more line correspondences, determine one or more point-to-point correspondences between corresponding portions of the first dataset and corresponding portions of the second dataset;
for each of the one or more point-to-point correspondences, determine a deviation value; and
perform operations that adjust the positioning of the one or more data points of the second dataset based at least on the deviation value of each of the one or more point-to-point correspondences.

5. The apparatus of claim 4, wherein the at least one processor is configured to apply a sliding window process to corresponding portions of the first dataset and the second dataset to determine the deviation value of each of the one or more point-to-point correspondences.

6. The apparatus of claim 1, wherein the first dataset includes a set of three-dimensional data points that characterize a three-dimensional map of the road network.

7. The apparatus of claim 1, wherein the at least one processor is configured to obtain the first dataset from another computing system.

8. The apparatus of claim 1, wherein the second dataset includes data characterizing a set of three dimensional data points associated with the road network.

9. The apparatus of claim 8, wherein the second dataset is based on sensor data.

10. The apparatus of claim 9, further comprising one or more sensors, wherein the sensor data is generated from the one or more sensors, and wherein the at least one processor is configured to receive the sensor data from the one or more sensors and generate the second dataset based on the sensor data.

11. The apparatus of claim 10, wherein the one or more sensors include a LIDAR sensor.

12. The apparatus of claim 11, wherein the apparatus is a vehicle, and wherein the apparatus includes the one or more sensors.

13. The apparatus of claim 11, wherein the at least one processor is configured to obtain the second dataset from a vehicle including the one or more sensors.

14. The apparatus of claim 1, wherein the at least one processor is further configured to:
transmit the optimized second dataset a computing device of a vehicle.

15. A non-transitory, machine-readable storage medium storing instructions that, when executed by at least one processor of a server, causes the at least one processor to perform operations that include:
generating a reference skeleton model based on a first dataset;
obtaining a second dataset associated with the road network;
generating a sensed skeleton model based on the second dataset;
determining a first topology of the reference skeleton model and a second topology of the sensed skeleton model, the first topology and the second topology each identifying and characterizing one or more nodes; and
based at least on the one or more nodes of the first topology and the one or more nodes of the second topology, performing operations that adjust a positioning of one or more data points of the second dataset.

16. A computer-implemented method performed by an application program executed on at least one processor of a vehicle, the computer-implemented method comprising:
generating a reference skeleton model based on a first dataset;
obtaining a second dataset associated with the road network;
generating a sensed skeleton model based on the second dataset;
determining a first topology of the reference skeleton model and a second topology of the sensed skeleton model, the first topology and the second topology each identifying and characterizing one or more nodes; and
based at least on the one or more nodes of the first topology and the one or more nodes of the second topology, performing operations that adjust a positioning of one or more data points of the second dataset.

17. The computer-implemented method of claim 16 further comprises:
updating one or more navigation processes of a user device, the one or more navigation processes includes updating mapping data.

18. The computer-implemented method of claim 17, further comprises:
adjusting an operating parameter of a vehicle based on the adjusted second dataset.

19. The computer-implemented method of claim 16, wherein the first topology and the second topology each further identifying one or more lines, and wherein the computer-implemented method further comprises:
determining one or more line correspondences between the reference skeleton model and the sensed skeleton model based at least on the first topology and the second topology;
for each of the one or more line correspondences, determining one or more point-to-point correspondences between corresponding portions of the first dataset and corresponding portions of the second dataset;
for each of the one or more point-to-point correspondences, determining a deviation value; and
performing operations that adjust the positioning of the one or more data points of the second dataset, based at least on the deviation value of each of the one or more point-to-point correspondences.

20. The computer-implemented method of claim 19, wherein determining the deviation value of each of the one or more point-to-point correspondences includes applying a sliding window process to corresponding portions of the first dataset and the second dataset.

21-30. (canceled)
